(19) United States
(12) Patent Application Publication
(10) Pub. No.: US 2025/0278753 A1
(43) Pub. Date: Sep. 4, 2025

(54) PRICE ESTIMATION FOR COLLECTIBLE CARDS

(71) Applicant: Collectors Universe, Inc., Santa Ana, CA (US)

(72) Inventors: Kassim Lovett, Falls Church, VA (US); Danylo Prykhodko, Naples, FL (US); David Shalamberidze, Naples, FL (US)

(73) Assignee: Collectors Universe, Inc., Santa Ana, CA (US)

(21) Appl. No.: 19/065,664

(22) Filed: Feb. 27, 2025

Related U.S. Application Data
(60) Provisional application No. 63/559,325, filed on Feb. 29, 2024.

(51) Int. Cl. G06Q 30/0201

(52) U.S. Cl. CPC G06Q 30/0206

(57) ABSTRACT

A system that utilizes machine learning and deep learning to estimate the value of a collectible card. The system utilizes artificial intelligence (AI) to estimate the value of the card based on a number of parameters, including trends, card specification, grade, and population statistics. The system can be used to as predictive analytics or predictive modeling of collectible card prices.

### CROSS-REFERENCE TO RELATED APPLICATIONS

This application for a utility patent claims the benefit of U.S. Provisional Application No. 63/559,325. Filed Feb. 29, 2024.

### BACKGROUND

Trading cards for athletes and other notable figures and characters have long been collected by young and old alike. Some may collect the trading cards for enjoyment, some may collect the cards in the hope of profit, and some may collect cards for both. Knowledge of value ascribed to a collected card therefore may be important to some. But even those who collect cards merely for enjoyment may also, from time to time, be curious about prices which may be obtained for their cards.

Unfortunately, prices for cards may vary widely, and small differences in a variety of matters may result in significant differences in card value. Moreover, many cards may be lightly traded, with possibly no recent transactions available, or even possibly never traded at all. Determining a value to be placed on a particular collected card may therefore be difficult.

### BRIEF SUMMARY OF THE INVENTION

Some aspects provide for estimating the value of a collectible card. In some embodiments artificial intelligence (AI) is used to estimate the value of the card. In some embodiments machine learning is used as predictive analytics or predictive modeling of collectible card prices. An exemplary machine learning tool used herein can include a deep learning model, a neural network, or a regression model, such as a gradient boosting machine, used to predict value differences between cards. The machine learning tool may also be referred to as a machine learning model herein. The machine learning tool, such as a neural network or a regression model, is trained using information relating to cards having determined values. In a regression model, the machine learning program is programmed to estimate and understand the relationships among variables. Regression analysis focuses on one dependent variable and a series of other changing variables, making it particularly useful for prediction and forecasting. As used herein, forecasting is understood as the process of making predictions about the future based on the past and present data and is commonly used to analyze trends.

In some embodiments, a machine learning model, or deep learning model, such as a neural network, is used to train a system to estimate and/or predict price estimates of collectible cards using information relating to pairs or triplets of cards having pre-determined values. In some embodiments, the information for each card comprises information related to the card other than the value of the card, which is encoded into a number or a vector. In some embodiments, the number is a real number or a vector. In some embodiments, the number is a floating point number or the vector represented as an array of floating point numbers. In some embodiments, floating point numbers may be used to store an approximate value, while a decimal stores an exact value. Exact numbers like amounts of money should use decimals, and approximate values like scientific measurements should use floating points.

In some embodiments, the information of the card includes information indicative of popularity of the cards. In some embodiments information indicative of popularity of the card is based on one, some, or all of a number of the same cards manufactured, a number of cards manufactured for the same player of the card, and a number of times the same cards, and/or similar cards, were requested to be graded by an entity engaged in grading of cards. Each card may be considered in a card space having at least one card information (other than value) dimension, and a value dimension; however, in some embodiments, more than one dimension other than value dimension may be used.

In some embodiments less than a total number of available pairs or triplets of cards are used for training the machine learning model. In some embodiments each card may be considered to be positioned in a card space having at least a card information (other than value) dimension and a value dimension. In some embodiments the card space may include more than two dimensions, for example having a plurality of dimensions for the card (other than value) information. In some embodiments cards may be selected for training of the machine learning model to maximize the card space. In some embodiments pairs or triplets of cards may be selected for training of the machine learning model so as to attempt to maximize the card space. In some embodiments pairs or triplets of cards may be selected for training of the machine learning model to maximize distance between pairs or triplets of cards in the card space. In some embodiments cards may be deselected, for example in an iterative manner for use in training of the machine learning model if the cards are too close to other cards in the card space.

In some embodiments cards of the card space used for training the machine learning model are cards with known values, and the known values can be considered verified values. In some embodiments the known values include unverified values. In some embodiments additional and/or augmented information relating to the cards is determined for cards with known values. In other examples, predictive price of a collectible card can be based on market trends. For example, based on market trends, an add-on factor or a multiplier can be used to augment the predictive price information.

In some embodiments (a) at least some first information of a collectible card is compared with at least some first information of a plurality of collectible cards to determine a specification of the collectible card, (b) vector distances between at least some second information (which may include the first information) of the collectible card and at least some second information (which may include the first information) of other collectible cards is determined, with values being known for the other collectible cards, and (c) value of the collectible card is estimated based on the vector distances and the values of the other collectible cards. In some embodiments a machine learning model trained using contrastive learning processes determines the vector distances.

In some embodiments datasets of information of collectible cards and values of the collectible cards are used to train the machine learning model. In some embodiments the values of the collectible cards include values from actual sales of collectible cards with actual information of the collectible cards. In some embodiments the values of the collectible cards include estimated values of the collectible cards to include collectible market trends. Collectible market trends can include accelerating changes in card prices, percentage volume changes of available cards, elapsed time between card ownerships, number of bidders per auction, price change in percentages, etc. In some embodiments the information of the collectible cards is generated based on estimated information of the collectible cards. In some embodiments the information of the collectible cards is based on information derived from images of the collectible cards.

These and other aspects of the invention are more fully comprehended upon review of this disclosure.

### BRIEF DESCRIPTION OF THE FIGURES

FIG. 1 is a block diagram of one embodiment of a backend architecture that enables access to an inference service that embodies a price estimation system in accordance with aspects of the present invention.

FIG. 2 is a flow diagram of a process for determining a price estimate for a collectible card, in accordance with aspects of the invention.

FIG. 3 is a process flow block diagram including price estimate training of a model, which may include a neural network, in accordance with aspects of the invention.

FIG. 4 is a flow diagram of a process for determining sales data for use in price estimate training of a machine learning model, in accordance with aspects of the invention.

FIG. 5 is a process flow diagram of a further process for determining a price estimate for a collectible card, in accordance with aspects of the invention.

### DETAILED DESCRIPTION

The detailed description set forth below in connection with the appended drawings is intended as a description of the presently preferred embodiments of a price estimation system equipped with machine learning for determining pricing for a collectible item provided in accordance with aspects of the present devices, systems, and methods and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

The system described herein may be implemented in a computer having a computer processor and a computer memory.

For purposes of this application, the terms “computer,” “computer device,” “server,” and similar terms, refer to a device and/or system of devices that include at least one computer processor, and some form of computer memory having a capability to store data. The computer may comprise hardware, software, and firmware for receiving, storing, and/or processing data as described below. For example, a computer may comprise any of a wide range of digital electronic devices, including, but not limited to, a server, a desktop computer, a laptop, a smart phone, a tablet, or any form of electronic device capable of functioning as described herein.

The term “computer processor” as used herein refers to an electrical component that performs operations on an external data source, such as a computer memory, typically in the form of a microprocessor, although any equivalent structure may be used.

The term “computer memory” as used herein refers to any tangible, non-transitory storage that participates in providing instructions to a processor for execution. Such a medium may take many forms, including but not limited to, non-volatile media, volatile media, and any equivalent media known in the art. Non-volatile media includes, for example, ROM, magnetic media, and optical storage media. Volatile media includes, for example, DRAM, which typically serves as main memory. Common forms of computer memory include, for example, hard drives and other forms of magnetic media, optical media such as CD-ROM disks, as well as various forms of RAM, ROM, PROM, EPROM, FLASH-EPROM, solid state media such as memory cards, and any other form of memory chip or cartridge, or any other medium from which a computer can read. While several examples are provided above, these examples are not meant to be limiting, but illustrative of several common examples, and any similar or equivalent devices or systems may be used that are known to those skilled in the art.

The term “database” as used herein, refers to any form of one or more (or combination of) relational databases, object-oriented databases, hierarchical databases, network databases, non-relational (e.g. NoSQL) databases, document store databases, in-memory databases, programs, tables, files, lists, or any form of programming structure or structures that function to store data as described herein.

The term “network” is defined to include any device or system for communicating information from one computer device to another. For example, a global computer network (e.g., the Internet) may be used, including any form of local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. In addition, communication links within LANs typically include twisted wire pair or coaxial cable, while communication links between networks may utilize analog telephone lines, full or fractional dedicated digital lines, Digital Subscriber Lines (DSLs), wireless links including satellite links, or other communications links known to those skilled in the art. The network may further include any form of wireless network, including cellular systems, WLAN, Wireless Router (WR) mesh, or the like. Access technologies such as 3G, 4G, 5G, and future access networks may enable wide area coverage for mobile devices. In essence, the wireless network may include any wireless communication mechanism known in the art by which information may travel between computers of the present system.

The above-described drawing figures illustrate aspects of the invention, a price estimation system 10 for determining a price estimate for collectable items, and more particularly to a system for using machine learning for determining a price for a collectable card.

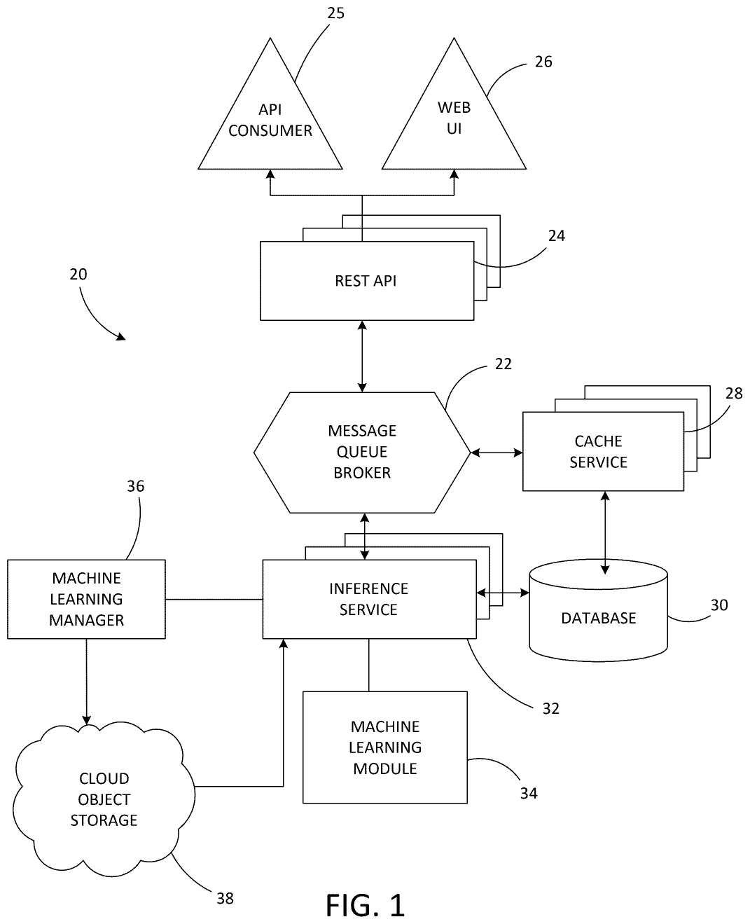

FIG. 1 is a block diagram of a price estimation system 10 including components to determine a price estimate for a collectible card in accordance with aspects of the invention. As used herein, collectibles or collectible cards broadly include information or images printed on a card stock and intended to be collected for enjoyment, for price appreciation, and/or for both. Non-limiting examples include sports cards, such as baseball, football and basketball cards, trading card games, such as Pokémon cards and Magic: The Gathering (MTG) cards, entertainment cards, such as Star Wars cards and Marvel & DC cards, and autographed cards. The system 10 includes a backend architecture 20 that enables access to an inference service that embodies the price estimation of the present invention. As shown in FIG. 1, the backend architecture 20 is based around a communication architecture such as a message queue broker 22, in this case an open source messaging system such as neural automatic transport service (“NATS”), although any form of message queue broker or equivalent system known in the art may be used. In this embodiment, the message queue broker 22 receives outside input via a REST API 24, which provides endpoints for direct interaction with the underlying system. The message queue broker 22 processes incoming requests and facilitates client-system communication. Requests and responses, in this embodiment, use JSON format, but other formats known in the art may be used to interact with consumer APIs 25, a web UI 26, and any other similar or equivalent systems. In this embodiment, NATS messaging is used for broadcasting notifications and receives results related to endpoint request activities.

The message queue broker 22 is also operably connected with a cache service 28 operably engaged with a database 30 that contains cached past predictions, so that the system can determine if the submission has already been received. The cache service avoids wasted computations and improves data access by maintaining cache past predictions. It fetches historical predictions from the database but also maintains a time-controlled in-memory cache for more requests. The expiration of in-memory cache items is adjustable via an environmental variable. The service updates the database to flag items requiring model predictions. NATS messaging is used for processing prediction requests and for updating the in-memory cache with real-time prediction data.

The message queue broker 22 is further operably connected with the inference system 32 that contains the AI or machine learning model 34. This is discussed in greater detail below. The inference system 32 of this embodiment executes prediction tasks using a machine learning manager 36 in an isolated process, communicating with the parent service (e.g., via stdin, stdout, and stderr). The machine learning manager 36, such as MLFLOW, and utilizing cloud object storage 38, such as Amazon® S3, or any equivalent system. In this embodiment, the service interfaces with the machine learning lifecycle management server, MLFlow, to receive model metadata, state, and artifacts of historical and the active model.

Part of this MLFlow orchestration also involves the service interacting with the cloud object storage, which serves as a storage location for model artifacts. Instance 0 of the stateful set, acting as a conductor, synchronizes model state information from MLFlow to the local database. The database is also used as a centralized ledger of items from which this service reserves items awaiting model prediction. NATS messaging is used to disseminate prediction results and to also coordinate model change events across inference service instances.

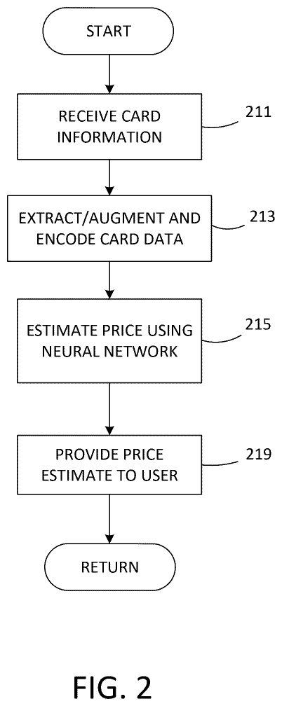

FIG. 2 is a flow diagram of a process for determining a price estimate for a collectible card, in accordance with one aspect of the invention. In some embodiments the process of FIG. 2 is performed by the system 10 of FIG. 1. In some embodiments the process of FIG. 2 is performed by one or more computer processors that are part of one or more servers utilized by the system.

In block 211 the process receives card information. The card information may be received by the server 130 of FIG. 1. The card information may be provided by a computer device, for example a computer device of FIG. 1. The computer device may be a computer device associated with a particular user, for example a user who desires a price estimate for a card that might be in their possession. In some embodiments the card information may be in the form of an image of the card. The image of the card may be, for example, generated by a specialized imaging station or an image capture device of or associated with a computer device, such as a cell phone, a scanner, or a digital imaging device. In some embodiments the card information may be a text description of the card.

In block 213 the process processes the received card information to generate information to be used in estimating a price of the card. In some embodiments the process extracts information from an image of the card (e.g., image part of the card image and/or text part of the card image), and determines an identity of the card based on the extracted information. In some embodiments the process correlates a textual description of the card with a dataset of information regarding cards, and determines an identity of the card based on the correlation. In some embodiments the process augments information relating to the card based on other information, for example popularity information for cards having the determined identity. In some embodiments the popularity information may comprise information of a number of cards manufactured and distributed for a particular card (e.g., a particular card having particular features for a particular player). In some embodiments the popularity information may comprise a number of times cards of the determined identity have been submitted to a card grading service for grading of the card. In some embodiments the process encodes the information relating to the card, including the augmented information in some embodiments, into one or more values. In some embodiments the information is encoded into an integer value. In some embodiments the information is encoded into a real value. In some embodiments the information is encoded into a floating point value.

In block 215 the process estimates a price of the card using a machine learning model, such as generated for a single spec and a grade combination. In another example, the process estimates a batch of multiple spec/grade combinations at once. Thus, the system contemplates receiving a stack or batch of collectible cards from a single requester and then generating price estimates for the batch. In some embodiments the machine learning model executes on one or more servers. In some embodiments the machine learning model has been trained to estimate the price of cards. In some embodiments the machine learning model has been trained using information and values of cards. In some embodiments the machine learning model has been trained using information and values for pairs or triplets of cards. In some embodiments the machine learning model has been trained using information and values for triplets of cards. In some embodiments the information includes information identifying a card specification. In some embodiments the information includes information identifying a card specification and population statistics for a card specification. The model can also be programmed to generate estimates based on population statistics of cards per player along with a single card based on population statistics. In some embodiments the population statistics comprise a number of cards manufactured and distributed for cards having that card specification. Non-limiting trading card manufacturers in which population statistics can be utilized include Topps, Upper Deck, Panini, In the Game, Press Pass, Tristar, Leaf, and Sage. Additionally, raw (ungraded) conditions are part of dataset features that can be used for both pair/triplet selection for model training and reference sale sampling during inference. In some embodiments the information includes a number of times cards having the card specification have been graded. In some embodiments a popularity of a card specification comprises an indication or weight based on a number of cards manufactured and distributed for cards having that card specification and a number of times cards having that card specification have been submitted for card grading.

In block 219 the process provides the price estimate for the card to the user. In some embodiments the process provides the price estimate to the user by providing information of the price estimate to a computer device associated with the user. In some embodiments the price estimate is for a range of grades for the card. In some embodiments the price estimate is for a specific grade for the card graded by a specific grading company. The process thereafter returns.

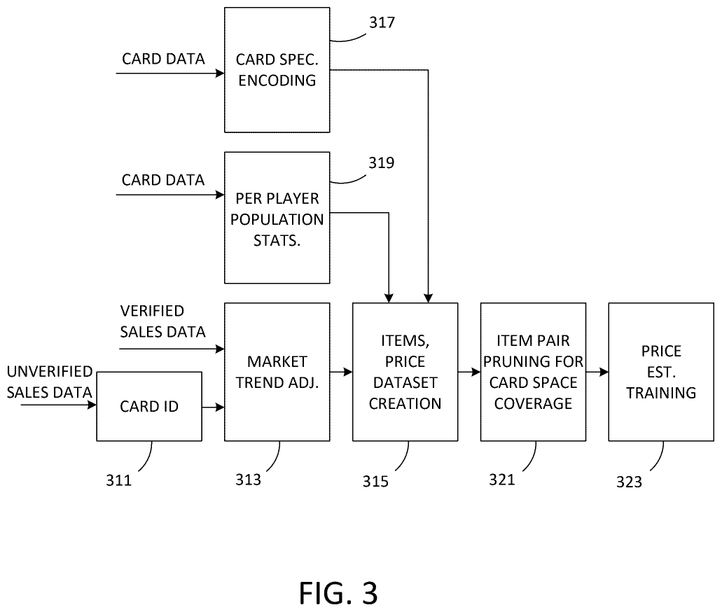

FIG. 3 is a process flow block diagram of price estimate training of a machine learning model, in accordance with aspects of the invention. In some embodiments the process of FIG. 3 is performed by a system, for example the system of FIG. 1. In some embodiments the process of FIG. 3 is performed by a server or other form of computer device, such as the system of FIG. 1. In some embodiments the process of FIG. 3 is performed by one or more processors on one or more servers. In some embodiments the machine learning tool comprises a neural network. In some embodiments the machine learning tool comprises a regression model. A regression model is a statistical model that estimates how one or more independent variables relate to a dependent variable. Regression models can be used to predict future values, foresee or interpret trends, and determine the impact of changes.

Turning first to the middle of the diagram, block 315 operates on information to form an items, price dataset for cards. The dataset includes card information (other than value) for a plurality of cards, by card specification, and an associated value or price for the cards. The card specification specifies cards that were nominally manufactured to have identical information and features. In some embodiments the card information is the card specification, or uniquely identifies the card specification from other card specifications. In some embodiments the card information may uniquely identify the card specification, and include additional information. For example, in some embodiments the card information may additionally include one, some or all of card specification population statistics, a number of times cards with the card specification have been submitted for grading (either ever or over a particular period of time), and/or card popularity.

Blocks 313, 317, and 319 are shown as providing information to block 315 for use in forming and/or updating the items, price dataset. Block 317 provides encoded card specification information, block 319 provides card specification population information or popularity information, and block 313 provides value or price information for cards. In some embodiments, operations of blocks 317 and 319 are combined in a single block, with the single block provided encoded card specification and population or popularity information.

Block 317 receives card data that includes a specification for each of a plurality of cards. For each card, block 317 encodes the specification into a number, for example a floating point number. In some embodiments the card data is textual, and block 311 utilizes a natural language processing model to encode the specification into the number. Optionally, the model is programmed to additionally process a multi-dimensional vector of values (model embedding) rather than just a single number.

Block 319 receives card data that includes per card (and/or in some embodiments per player) distribution information. In some embodiments the distribution information consists of or comprises numbers of cards manufactured and distributed for cards of each card specification, or for cards having a particular player.

Block 313 receives sales price information for a plurality of cards, and updates those sale prices to account for market trends since the date of the sales. The sales price can be verified sales, in which the sale price of a card is believed to be authentic and for which the card specification ID is known. Less preferred, the sales price can also be for unverified sales, which can be viewed as not authentic. Unverified sales may be, for example, sales information for cards for which the card specification is not known. In such situations, a textual description of the card or an image of the card may be available. In such cases, block 311 may receive the unverified sales information, and determine a card specification for the card, and provide that information to block 313.

The items, price dataset may contain information of sales of many, many cards. In some embodiments the information of sales of the cards may be of such a volume that training of a neural network to estimate card prices using all of the information in the dataset may not be able to be performed in a timely manner, or possibly ever. Accordingly, block 321 prunes the data to be used in training of the machine learning model. The machine leaning model may be used to estimate the price of a collectable, or to forecast future value.

In some embodiments the data used to train the machine learning model comprises card and sale price information for pairs or triplets of cards. It should be recognized, however, that single cards or triplets of cards may be used in various embodiments. The card information may be in the form of an encoded floating point number, some other number, or a vector. In some embodiments block 321 considers the card and sale price information to form a card space. Generally, a card's grading status that includes grade and the grading company, or the raw condition of the card for ungraded cards are part of the attributes of sales records in addition to specification and price. In such a card space it may be found that cards may often be found grouped in a discrete number of groupings, with cards of a particular grouping closer to other cards in that grouping than to cards in any other grouping.

In some embodiments, if some of the groupings have large numbers of cards (e.g., more than three), a number of cards in each grouping may be deselected for use in training the machine learning model. In some embodiments, cards are deselected for use in training the machine learning model so as to decrease a density of remaining cards in the grouping. Pairs and triplets are selected, and are arranged to have the greatest possible distance between them.

In some embodiments pairs or triplets of cards are selected for use in training the machine learning model based on a distance between the cards in the card space, with for example cards having greatest distance between them being selected for training of the machine learning model. In some embodiments pairs or triplets of cards are selected for use in training the machine learning model based on an algorithm to maximize coverage of the card space by the pairs or triplets of cards.

In block 323 price estimate training is performed for the machine learning model, using the selected card pairs (or cards, or card triplets, in some embodiments).

As illustrated in FIG. 3, the method of training the machine learning model comprises the steps of (a) comparing at least some first information of a collectible card with at least some first information of a plurality of collectible cards to determine a specification of the collectible card; (b) determining vector distances between at least some second information, which may include the first information, of the collectible card and at least some second information, which may include the first information, of other collectible cards, with values being known for the other collectible cards; and (c) estimating a value of the collectible card based on the vector distances and the values of the other collectible cards.

The machine learning model may be trained using contrastive learning processes to determine the vector distances. In one embodiment, the values of collectible cards includes actual sales of collectible cards with actual information of the collectible cards. This may include estimated values of the collectible cards to include collectible market trends, accelerating changes in card prices, percentage volume changes of available cards, elapsed time between card ownerships, number of bidders per auction, price change in percentages, etc. In some embodiments the information of the collectible cards is generated based on estimated information of the collectible cards, or based on information derived from images of the collectible cards.

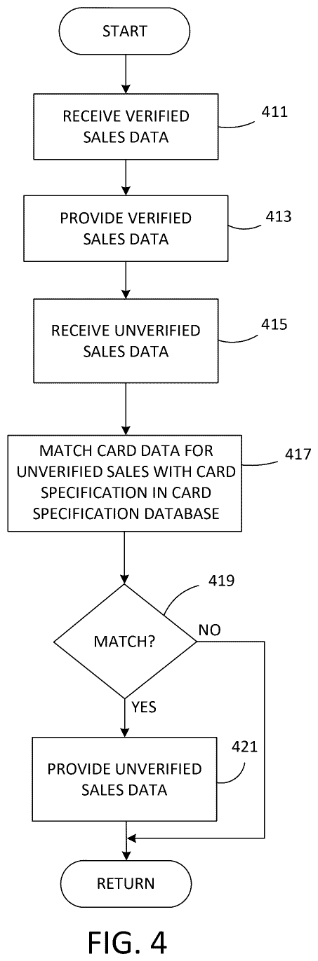

FIG. 4 is a flow diagram of a process for determining sales data for use in price estimate training of a machine learning model, in accordance with aspects of the invention. In some embodiments the process of FIG. 4 is performed by a system, for example the system of FIG. 1. In some embodiments the process of FIG. 4 is performed by a server, for example the server 113b of FIG. 1. In some embodiments the process of FIG. 4 is performed by one or more processors on one or more servers. In some embodiments the process of FIG. 4 performs some operations of blocks 311 and 313 of FIG. 3. In some embodiments the machine learning tool comprises a neural network. In some embodiments the machine learning tool comprises a regression model.

Block 411 receives verified sales data for cards. The verified sales data may comprise a card specification, a grade, grading company, and a sales price and date of sale for cards. The verified sales data may be received by a server, from one or more databases including such information. In other examples, fewer or additional data may be included to make up verified sales data.

Block 413 provides the verified sales data for the items price dataset creation, as shown in FIG. 3. Block 415 illustrates the receipt of unverified sales data, also as illustrated in FIG. 3. The unverified sales data may comprise information regarding a card that has been sold, and a sales price and date of sale for the card. The information regarding the card may be a textual description of the card and/or an image of the card.

Block 417 matches the textual description of the card and/or information of the image of the card to a card specification stored in a data structure containing information of card specifications.

Block 419 determines if there is such a match. If so, the process provides the unverified sales data (and the card specification) to other components and returns. If block 419 determines there is no match, the process also returns. Optionally, the system is programmed to generate price estimates for collectible cards that are not dependent on the cards' specification. For example, the card's information like subject, variety, year, serial number, manufacturer, etc. can be used to generate the card's price estimate without resorting to the card's specification.

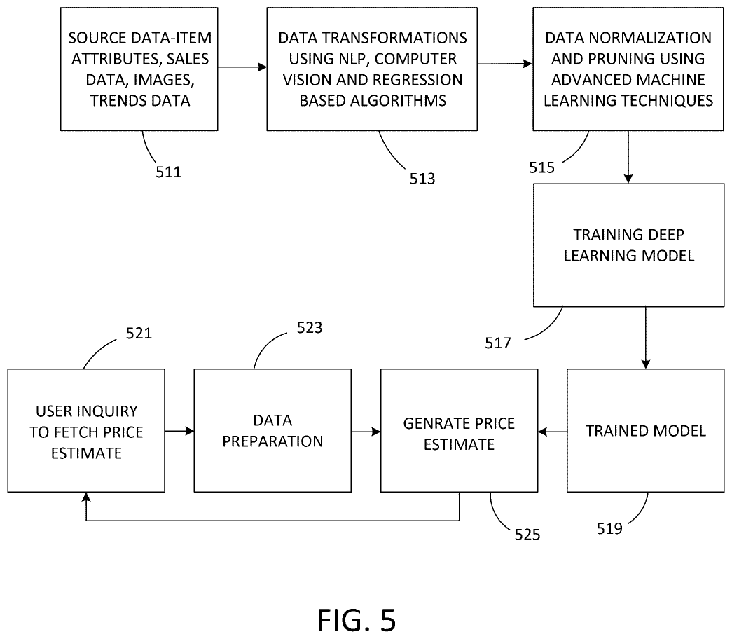

FIG. 5 is a process flow diagram of a further process for determining a price estimate for a collectible card, in accordance with aspects of the invention. In some embodiments the process of FIG. 5 is performed by a system, for example the system of FIG. 1. In some embodiments the process of FIG. 5 is performed by a server, for example the server 113a of FIG. 1. In some embodiments the process of FIG. 5 is performed by one or more processors on one or more servers.

Blocks 511-517 relate to training of a machine learning tool to perform price estimation. Block 511 receives information regarding card information, sales information, and market trends. Block 513 performs data extraction and data transformation on the received information, for example to form a dataset of card specification information and price information. Block 515 process data of the dataset to provide a manageable set of card specification information and price information for use in training a neural network to perform price estimation. Block 517 trains the machine learning tool to perform price estimation using the manageable set of card specification information and price information, to provide a trained machine learning tool 519.

Block 521 represents a user computer device. The user computer device may generate a user inquiry for a price estimate for a card. The user inquiry may be generated in response to user inputs to the user computer device. The user inquiry may include a card identification and/or textual and/or one or more images of the card. User can be a person, a program or alternate routine that is designed to request price estimate information by providing necessary information.

Block 523 performs data preparation for submission of a price estimate request to the neural network trained to perform price estimation for cards. The data preparation may include determining a card specification for the card, determining population and/or popularity statistics for the card, and encoding of the card specification, and possibly population and/or popularity information into a number or vector. The data preparation may be performed by a server or multiple servers.

Block 525 determines a price estimate for the card, using the trained machine learning tool. The price estimate is provided back to the user computer device that requested the price estimate for the collectible card.

Although the invention has been discussed with respect to various embodiments, it should be recognized that the invention comprises the novel and non-obvious claims supported by this disclosure.

### EXAMPLE EMBODIMENTS

The following are numbered example embodiments of the apparatuses, devices, systems, and methods related to machine learning and deep learning to estimate values of collectible cards. The system utilizes artificial intelligence (AI) to estimate the value of the card based on a number of parameters, including trends, card specification, grade, and population statistics. The system can be used to as predictive analytics or predictive modeling of collectible card prices. The examples identified below or any other examples disclosed herein may be combined in whole or in part, unless the context indicates otherwise. Elements of the examples disclosed herein, if applicable, are not limiting.

Example 1. A method of training a machine learning model, the method comprising the steps of: (a) comparing at least some first information of a collectible card with at least some first information of a plurality of collectible cards to determine a specification of the collectible card; (b) determining vector distances between at least some second information, which may include the first information, of the collectible card and at least some second information, which may include the first information, of other collectible cards, with values being known for the other collectible cards; and (c) estimating a value of the collectible card based on the vector distances and the values of the other collectible cards.

Example 2. The assembly, system, device, apparatus, and method of any of the above Examples alone or in combination, wherein the method of training a machine learning model is configured for use on collectible cards to estimate price information of the collectible cards.

Example 3. The assembly, system, device, apparatus, and method of any of the above Examples alone or in combination, wherein the machine learning model is trained using contrastive learning processes to determine the vector distances.

Example 4. The assembly, system, device, apparatus, and method of any of the above Examples alone or in combination, wherein the estimated values of collectible cards include actual sales of collectible cards with actual information of the collectible cards.

Example 5. The assembly, system, device, apparatus, and method of any of the above Examples alone or in combination, wherein estimated values of the collectible cards include collectible market trends.

Example 6. The assembly, system, device, apparatus, and method of any of the above Examples alone or in combination, wherein estimated values of the collectible cards include accelerating changes in card prices.

Example 7. The assembly, system, device, apparatus, and method of any of the above Examples alone or in combination, wherein estimated values of the collectible cards include percentage volume changes of available cards.

Example 8. The assembly, system, device, apparatus, and method of any of the above Examples alone or in combination, wherein estimated values of the collectible cards include elapsed time between card ownerships.

Example 9. The assembly, system, device, apparatus, and method of any of the above Examples alone or in combination, wherein estimated values of the collectible cards include a determined number of bidders per auction.

Example 10. The assembly, system, device, apparatus, and method of any of the above Examples alone or in combination, wherein estimated values of the collectible cards include relative price changes.

Example 11. The assembly, system, device, apparatus, and method of any of the above Examples alone or in combination, wherein the information of the collectible cards is generated based on estimated information of the collectible cards.

Example 12. The assembly, system, device, apparatus, and method of any of the above Examples alone or in combination, wherein the information of the collectible cards is generated based on information derived from images of the collectible cards.

Example 13. A price estimation system for determining an estimated price for collectable cards, the price estimation system comprising: one or more computer devices having a computer processor and computer memory, the computer memory storing executable code that, when executed by the computer processor, enables the computer system to perform a process that comprises the following steps: collecting datasets of information regarding the collectible cards, the datasets of information including values of the collectible cards, and also at least one piece of information related to the card other than the value of the card, which is encoded into a number or a vector; training a machine learning model using the collected datasets; receiving card data of the collectable card; and using machine learning to determine the estimated price of the collectable card.

Example 14. The assembly, system, device, apparatus, and method of any of the above Examples alone or in combination, wherein the at least one piece of information related to the card other than the value of the card is encoded into a real number or a vector.

Example 15. The assembly, system, device, apparatus, and method of any of the above Examples alone or in combination, wherein the at least one piece of information related to the card other than the value of the card is encoded into a floating point number or a vector represented as an array of floating point numbers.

Example 16. The assembly, system, device, apparatus, and method of any of the above Examples alone or in combination, wherein the at least one piece of information related to the card other than the value of the card is information indicative of popularity of the cards.

Example 17. The assembly, system, device, apparatus, and method of any of the above Examples alone or in combination, wherein the information indicative of popularity of the card includes a number of the same cards manufactured, a number of cards manufactured for the same player of the card, and a number of times the same cards, and/or similar cards, were requested to be graded by an entity engaged in grading of cards.

Example 18. A method of training a machine learning model for use to perform price estimation on collectible cards, the method comprising the steps of: (a) receiving text information on a collectible card, said text information comprising specification information of the collectible card; (b) encode the specification information of the collectible card into a floating point number or use a natural language processing model to encode the specification into a floating point number; (d) comparing the specification of the collectible card to specification of other collectible cards, with values being known for the other collectible cards; and (c) estimating a value of the collectible card based on the vector distances and the values of the other collectible cards.

Example 19. The assembly, system, device, apparatus, and method of any of the above Examples alone or in combination, wherein future value of the collectible card is predicted based on a number of times the same card or similar cards were requested to be graded by an entity engaged in grading of cards.

Example 20. The assembly, system, device, apparatus, and method of any of the above Examples alone or in combination, wherein machine learning is used to train a system to at least one of estimate and predict price estimates of collectible cards using information relating to at least pairs of cards having determined values.

Example 21. The assembly, system, device, apparatus, and method of any of the above Examples alone or in combination, wherein information on triplets of cards having determined values is used for training.

Example 22. The assembly, system, device, apparatus, and method of any of the above Examples alone or in combination, wherein the information related to the collectible card, other than the value of the card, is encoded into a number or a vector.

Example 23. The assembly, system, device, apparatus, and method of any of the above Examples alone or in combination, wherein the number is a real number or a vector. If a vector, the vector is an array of floating point numbers.

Example 24. The assembly, system, device, apparatus, and method of any of the above Examples alone or in combination, wherein the number is a floating point number.

Example 25. The assembly, system, device, apparatus, and method of any of the above Examples alone or in combination, wherein other collectible cards used for training are cards with known value. Known values can be verified values.

Example 26. The assembly, system, device, apparatus, and method of any of the above Examples alone or in combination, wherein predictive price of a collectible card is based on market trends. If market trend is determined, an add-on factor or a multiplier can be used to augment the predictive price information.

Example 27. The assembly, system, device, apparatus, and method of any of the above Examples alone or in combination, wherein the values of the collectible cards include values from actual sales of collectible cards with actual information of the collectible cards.

Example 28. The assembly, system, device, apparatus, and method of any of the above Examples alone or in combination, wherein the values of the collectible cards comprise estimated values of the collectible cards and collectible market trends.

Example 29. The assembly, system, device, apparatus, and method of any of the above Examples alone or in combination, wherein the collectible market trends comprise information showing at least one of accelerating changes in card prices, percentage volume changes of available cards, elapsed time between card ownerships, number of bidders per auction, and price change in percentages.

Example 30. The assembly, system, device, apparatus, and method of any of the above Examples alone or in combination, wherein the information of the collectible cards is generated based on estimated information of the collectible cards.

Example 31. The assembly, system, device, apparatus, and method of any of the above Examples alone or in combination, wherein the information of the collectible cards is based on information derived from images of the collectible cards.

Example 31. The assembly, system, device, apparatus, and method of any of the above Examples alone or in combination, wherein the price estimation is performed by one or more processors that are part of one or more servers.

Example 32. The assembly, system, device, apparatus, and method of any of the above Examples alone or in combination, wherein information of the collectible card is in the form of an image, which contains both graphic and text.

Example 33. The assembly, system, device, apparatus, and method of any of the above Examples alone or in combination, wherein the information is extracted information from an image of the card and identity of the card is determined based on the extracted information.

Example 34. The assembly, system, device, apparatus, and method of any of the above Examples alone or in combination, wherein textual description of the collectible card is correlated with a dataset of information of the same or similar collectible cards to determine an identity of the collectible card based on the correlation.

Example 35. The assembly, system, device, apparatus, and method of any of the above Examples alone or in combination, wherein the collectible card information is augmented based on other information related to the collectible card. The other information related to the collectible card comprises a nickname or a slang used to refer to the collectible card.

Example 36. The assembly, system, device, apparatus, and method of any of the above Examples alone or in combination, wherein popularity information of the collectible card is used as a factor in projecting or estimating the value of the collectible card. The popularity information can comprise information of a number of cards manufactured and distributed for the same or similar collectible cards.

Example 37. The assembly, system, device, apparatus, and method of any of the above Examples alone or in combination, wherein the popularity information comprises a number of times the same or similar collectible cards have been submitted to a card grading service for grading of the card.

Example 38. The assembly, system, device, apparatus, and method of any of the above Examples alone or in combination, wherein the collectible card information relating to the collectible card is encoded into an integer value, a real value, or a floating point value.

Example 38. The assembly, system, device, apparatus, and method of any of the above Examples alone or in combination, wherein price estimate is performed for a stack or a batch of collectible cards from a single requester.

Example 39. The assembly, system, device, apparatus, and method of any of the above Examples alone or in combination, wherein the collectible card information includes information identifying a card specification and population statistics for a card specification.

Example 40. The assembly, system, device, apparatus, and method of any of the above Examples alone or in combination, wherein price estimate is based on population statistics of cards per player.

Example 41. The assembly, system, device, apparatus, and method of any of the above Examples alone or in combination, wherein price estimate is based on a single card's population statistics.

Example 41. The assembly, system, device, apparatus, and method of any of the above Examples alone or in combination, wherein population statistics comprise a number of cards manufactured and distributed for cards having that card specification. In some examples, trading card manufacturers in which population statistics can be utilized include Topps, Upper Deck, Panini, In the Game, Press Pass, Tristar, Leaf, and Sage.

Example 42. The assembly, system, device, apparatus, and method of any of the above Examples alone or in combination, wherein the collectible card information includes a number of times collectible cards having the card specification have been graded.

Example 43. The assembly, system, device, apparatus, and method of any of the above Examples alone or in combination, wherein popularity of a card specification comprises an indication or weight based on a number of cards manufactured and distributed for cards having that card specification and a number of times cards having that card specification have been submitted for card grading.

Example 44. The assembly, system, device, apparatus, and method of any of the above Examples alone or in combination, wherein the price estimate is provided to the requester by providing information of the price estimate to a compute device associated with the requester.

Example 45. The assembly, system, device, apparatus, and method of any of the above Examples alone or in combination, wherein the price estimate is for a range of grades for the card.

Example 46. The assembly, system, device, apparatus, and method of any of the above Examples alone or in combination, wherein the price estimate is for a specific grade for the card graded by a specific grading company.

Example 47. The assembly, system, device, apparatus, and method of any of the above Examples alone or in combination, wherein verified sales data comprise a card specification, a grade, grading company, and a sales price and date of sale for cards. The verified sales data may be received by a server, from one or more databases. Fewer or additional data may be included to make up verified sales data.

Example 48. The assembly, system, device, apparatus, and method of any of the above Examples alone or in combination, wherein the textual description of the collectible card and/or information of the image of the collectible card to a card specification stored in a data structure containing information of card specifications are matched.

Example 49. The assembly, system, device, apparatus, and method of any of the above Examples alone or in combination, wherein price estimates for collectible cards that are not dependent on the cards' specification are generated.

Example 50. The assembly, system, device, apparatus, and method of any of the above Examples alone or in combination, wherein card's information other than the card's specification comprises subject, variety, year, serial number, and manufacturer.

What is claimed is:

1. A method of training a machine learning model, the method comprising the steps of:
(a) comparing at least some first information of a collectible card with at least some first information of a plurality of collectible cards to determine a specification of the collectible card;
(b) determining vector distances between at least some second information, which may include the first information, of the collectible card and at least some second information, which may include the first information, of other collectible cards, with values being known for the other collectible cards; and
(c) estimating a value of the collectible card based on the vector distances and the values of the other collectible cards.

2. The method of claim 1, wherein the machine learning model is trained using contrastive learning processes to determine the vector distances.

3. The method of claim 1, wherein the estimated values of collectible cards include actual sales of collectible cards with actual information of the collectible cards.

4. The method of claim 1, wherein estimated values of the collectible cards include collectible market trends.

5. The method of claim 1, wherein estimated values of the collectible cards include accelerating changes in card prices.

6. The method of claim 1, wherein estimated values of the collectible cards include percentage volume changes of available cards.

7. The method of claim 1, wherein estimated values of the collectible cards include elapsed time between card ownerships.

8. The method of claim 1, wherein estimated values of the collectible cards include a determined number of bidders per auction.

9. The method of claim 1, wherein estimated values of the collectible cards include relative price changes.

10. The method of claim 1, wherein the information of the collectible cards is generated based on estimated information of the collectible cards.

11. The method of claim 1, wherein the information of the collectible cards is generated based on information derived from images of the collectible cards.

12. A price estimation system for determining an estimated price for collectable cards, the price estimation system comprising:
one or more computer devices having a computer processor and computer memory, the computer memory storing executable code that, when executed by the computer processor, enables the computer system to perform a process that comprises the following steps:
collecting datasets of information regarding the collectible cards, the datasets of information including values of the collectible cards, and also at least one piece of information related to the card other than the value of the card, which is encoded into a number or a vector;
training a machine learning model using the collected datasets;
receiving card data of the collectable card; and
using machine learning to determine the estimated price of the collectable card.

13. The price estimation system of claim 12, wherein the at least one piece of information related to the card other than the value of the card is encoded into a real number or a vector.

14. The price estimation system of claim 12, wherein the at least one piece of information related to the card other than the value of the card is encoded into a floating point number or a vector represented as an array of floating point numbers.

15. The price estimation system of claim 12, wherein the at least one piece of information related to the card other than the value of the card is information indicative of popularity of the cards.

16. The price estimation system of claim 15, wherein the information indicative of popularity of the card includes a number of the same cards manufactured, a number of cards manufactured for the same player of the card, and a number of times the same cards, and/or similar cards, were requested to be graded by an entity engaged in grading of cards.
